(19) United States
(12) Patent Application Publication
(10) Pub. No.: US 2013/0057224 A1
(43) Pub. Date: Mar. 7, 2013

(54) CONTROL SYSTEM OF BATTERY PACK AND METHOD OF CHARGING AND DISCHARGING USING THE SAME

(71) Applicants: Looney Choi, Yongin-si (KR); Kiho Seo, Yongin-si (KR)

(72) Inventors: Looney Choi, Yongin-si (KR); Kiho Seo, Yongin-si (KR)

(73) Assignee: Samsung SDI Co., Ltd., Yongin-si (KR)

(21) Appl. No.: 13/555,697

(22) Filed: Jul. 23, 2012

(30) Foreign Application Priority Data
Sep. 2, 2011 (KR) 10-2011-0088937

(51) Int. Cl. H02J 7/00

(52) U.S. Cl. 320/136

(57) ABSTRACT

A control system of a battery pack and a method of charging and discharging the battery pack using the method are disclosed. The control system includes a plurality of battery cells, a balancing unit that selectively balances the battery cells, and a controller that controls a balancing operation. The controller calculates an amount of charge current accumulation and measures voltages of the respective battery cells, and controls a balancing operation of at least one of the battery cells if the calculated amount of charge current accumulation is in a range of a reference capacity values.

### CROSS-REFERENCE TO RELATED APPLICATIONS

This application claims the benefit of Korean Patent Application No. 10-2011-0088937, filed on Sep. 2, 2011, the disclosure of which is incorporated herein in its entirety by reference.

### BACKGROUND

1. Field

The disclosed technology relates generally to a control system of a battery pack and a method of charging and discharging the battery pack using the method.

2. Description of the Related Technology

A rechargeable battery is manufactured in the form of a cell and is joined with a circuit to form a battery pack. The rechargeable battery is charged or recharged by an external power source or a load via an external terminal of the battery pack. The battery pack may include a single battery cell or multiple battery cells.

In a battery pack having multiple battery cells, the respective battery cells may degrade due to repeated charging/discharging operations. Since the useful lifetime of each battery cell will differ, charge and discharge time durations and amounts of the respective battery cells are different. A more degraded cell may have a shortened time for charging or discharging, so that it fully charged or discharged before the remaining cells, and the remaining cells are only partially charged or discharged. If this condition persists, degradation of the cell may become severe, and may result in a fire or an explosion.

### SUMMARY OF CERTAIN INVENTIVE ASPECTS

One inventive aspect is a control system of a battery pack. The system includes a plurality of battery cells, a balancing unit configured to selectively balance the battery cells, and a controller configured to control the balancing unit. The controller calculates an amount of charge current accumulation and measures voltages of the respective battery cells, and controls the balancing of at least one of the battery cells if the calculated amount of charge current accumulation is within a range of reference capacity values.

Another inventive aspect is a method of charging and discharging a battery pack using a control system of the battery pack. The method includes calculating an amount of charge current accumulation based on current of the plurality of battery cells and a time for the flow of the current, comparing the calculated amount of current accumulation with a reference capacity value, and if the calculated amount of current accumulation is within a range of reference capacity values, sensing voltages of individual battery cells, comparing the sensed voltages of the individual battery cells with each other, and controlling battery cells having relatively high voltages to be balanced based on the voltage difference between the individual battery cells.

### BRIEF DESCRIPTION OF THE DRAWINGS

The accompanying drawings are included to provide further understanding of the present disclosure, and are incorporated in and constitute a part of this specification. The drawings illustrate certain embodiments of the present disclosure and, together with the description, serve to explain principles of the present disclosure. In the drawings:

FIG. 1 is a circuit diagram illustrating a configuration of a control system of a battery pack according to an embodiment;

FIG. 2 is a flow chart schematically illustrating a method of charging and discharging using the control system shown in FIG. 1;

FIG. 3 is a flow chart illustrating the method of charging and discharging shown in FIG. 2; and

FIG. 4 is a graph illustrating voltage differences when balancing of a plurality of battery cells is performed by the method shown in FIG. 2.

### DETAILED DESCRIPTION OF CERTAIN INVENTIVE EMBODIMENTS

Certain embodiments are described more fully hereinafter with reference to the accompanying drawings; however, they may be embodied in different forms and should not be construed as limited to the embodiments set forth herein. Rather, these embodiments are provided so that this disclosure will be thorough and complete.

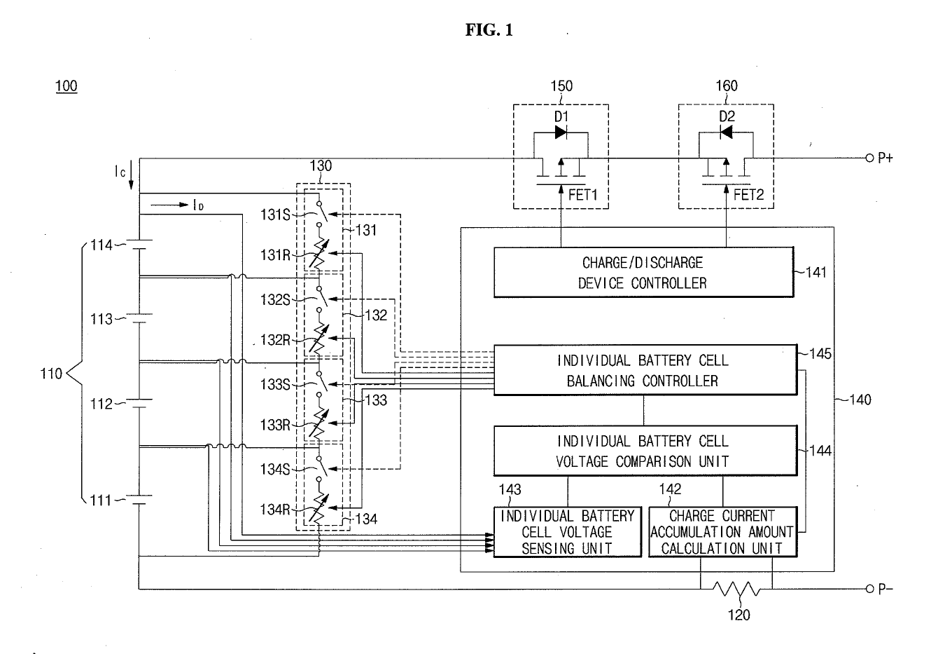

Hereinafter, a control system 100 of a battery pack according to an embodiment is described in detail. FIG. 1 is a circuit diagram illustrating a configuration of the control system 100 of a battery pack according to an embodiment. The control system 100 of a battery pack includes a battery pack 110, a balancing unit 130, and a controller 140.

The battery pack control system 100 calculates an amount of charge current accumulation of the battery pack 110, measures voltages of individual battery cells 111, 112, 113 and 114 if the amount of charge current accumulation becomes 5 to 15% of a charge capacity, and charges the battery cells 111, 112, 113 and 114 while balancing battery cells having relatively high voltages.

The battery pack 110 has the plurality of rechargeable battery cells 111, 112, 113 and 114 connected to each other in series. Each of the battery cells 111, 112, 113 and 114 may be one selected from a typical lithium ion battery, lithium polymer battery and equivalents thereof, but aspects of the present invention are not limited thereto. In addition, the number of battery cells included in the battery pack 110 may vary according to the power capacity required by an external system, but the present invention does not limit the number of battery cells included in the battery pack 110 to that illustrated herein. The battery cells 111, 112, 113 and 114 are connected in series to external terminals P+ and P− connected to the external system.

The battery pack 110 includes a current sensor 120 to calculate an amount of charge current accumulation. The current sensor 120 is electrically connected to an analog front end and/or a controller to control a current flowing in the battery pack 110. The configuration and operation of the current sensor 120 may be similar to those well known to those of ordinary skill in the art.

In order to sequentially or simultaneously balance the battery cells 111, 112, 113 and 114, the balancing unit 130 is connected in parallel to each of the individual battery cells 111, 112, 113 and 114. In addition, the balancing unit 130 includes a plurality of switches 131S, 132S, 133S and 134S turned on or off by a controller 140 and a plurality of variable resistors 131R, 132R, 133R and 134R connected between each of the switches 131S, 132S, 133S and 134S, which will later be described.

The variable resistors 131R, 132R, 133R and 134R may be digital variable resistors. Resistance values of the digital variable resistors are adjusted based on a voltage difference between each of the individual battery cells 111, 112, 113 and 114 and a reference cell for balancing, which is provided from the controller 140.

In addition, discharge currents flowing toward balancing units 131, 132, 133 and 134 connected in parallel to the individual battery cells 111, 112, 113 and 114 are less than charge currents. Therefore, during charging, the individual battery cells 111, 112, 113 and 114 are balanced such that battery cells having higher voltages than a voltage of a balancing reference battery cell are discharged by the voltage difference between the battery cells.

The controller 140 includes a charge/discharge device controller 141, a charge current accumulation amount calculation unit 142, an individual battery cell voltage sensing unit 143, an individual battery cell voltage comparison unit 144 and an individual battery cell balancing controller 145. The charge/discharge device controller 141, a charge device 150 and a discharge device 160 control over-charge or over-discharge of the battery pack 110.

The charge device 150 and the discharge device 160 are connected in series to each other along a large-current path between an external terminal 120 and the battery pack 110 to control charge or discharge of the battery pack 110. Each of the charge device 150 and the discharge device 160 includes a field effect transistor (FET). The FET includes a parasitic diode (D). More specifically, the charge device 150 includes an FET1 and a parasitic diode (D1), and the discharge device 160 includes an FET2 and a parasitic diode (D2). A source and a drain of the FET1 are connected in a direction opposite to a direction in which a source and a drain of the FET2 are connected. With this configuration, the FET1 of the charge device 150 controls the flow of current from an external terminal (P+) to the battery pack 110, and the FET2 of the discharge device 160 controls the flow of current from the battery pack 110 to the external terminal (P+). In addition, the parasitic diodes D1 and D2 respectively included in the charge device 150 and the discharge device 160 allow current to flow in the opposite direction to that of the current controlled by the FET1 and the FET2, respectively.

While the charge device 150 and the discharge device 140 include the FET1 and the FET2, respectively, aspects of the present invention are not limited thereto and other kinds of switching devices may be used.

The charge current accumulation amount calculation unit 142 is electrically connected to opposite ends of the current sensor 120 and calculates a current value by measuring a variation in the voltage difference between the opposite ends of the current sensor 120. Here, the current value is a negative value during charging, and is a positive value during discharging. The charge current accumulation amount is calculated by measuring a time for the flow of current.

The individual battery cell voltage sensing unit 143 compares the calculated amount of current accumulation with a reference capacity value and senses voltages of the respective battery cells 111, 112, 113 and 114 if the calculated amount of charge current accumulation falls under a range of the reference capacity value. The reference capacity value is set to about 5% to about 15% of charge capacity of the battery pack 110. In some embodiments, if the amount of current accumulation is greater than or equal to about 10% of the charge capacity, it is determined that charge polarization voltages of the individual battery cells 111, 112, 113 and 114 are equal to each other, and the voltages of the respective battery cells 111, 112, 113 and 114 are sensed.

The individual battery cell voltage comparison unit 144 compares the sensed voltages of the individual battery cells 111, 112, 113 and 114. The individual battery cell voltage comparison unit 144 compares the sensed voltages based on the voltage of a first battery cell having the lowest voltage, which is to be denoted by reference numeral 111, among the individual battery cells 111, 112, 113 and 114. Voltage differences of the remaining battery cells 112, 113 and 114 are compared based on the voltage of the first battery cell 111.

The individual battery cell balancing controller 145 controls operations of the balancing units 131, 132, 133 and 134 connected in parallel to the individual battery cells 111, 112, 113 and 114 to perform balancing of the battery cells 112, 113 and 114 having relatively high voltages according to the voltage differences compared by the individual battery cell voltage comparison unit 144. Here, the individual battery cell balancing controller 145 sets resistance values 132R, 133R and 134R of the variable resistors, and sequentially or simultaneously turns on the switches 132S, 133S and 134S to operate the balancing units 132, 133 and 134. The battery cells 112, 113 and 114 are discharged by the operations of the balancing units 132, 133 and 134 such that the voltages thereof become the voltage of the first battery cell 111 during charging.

Hereinafter, a method of charging and discharging using the control system 100 will be described.

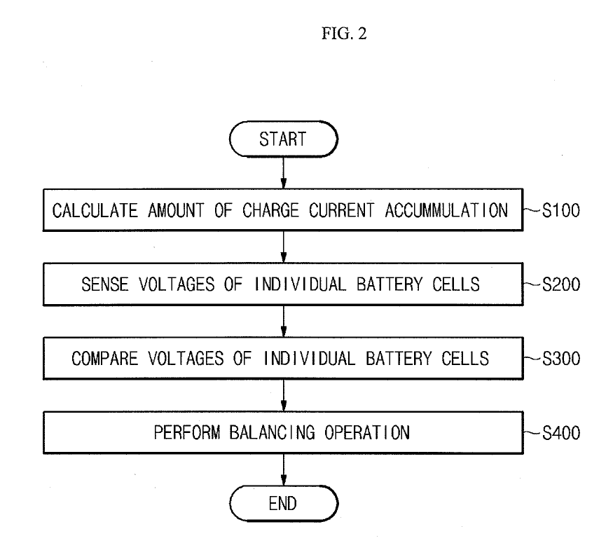

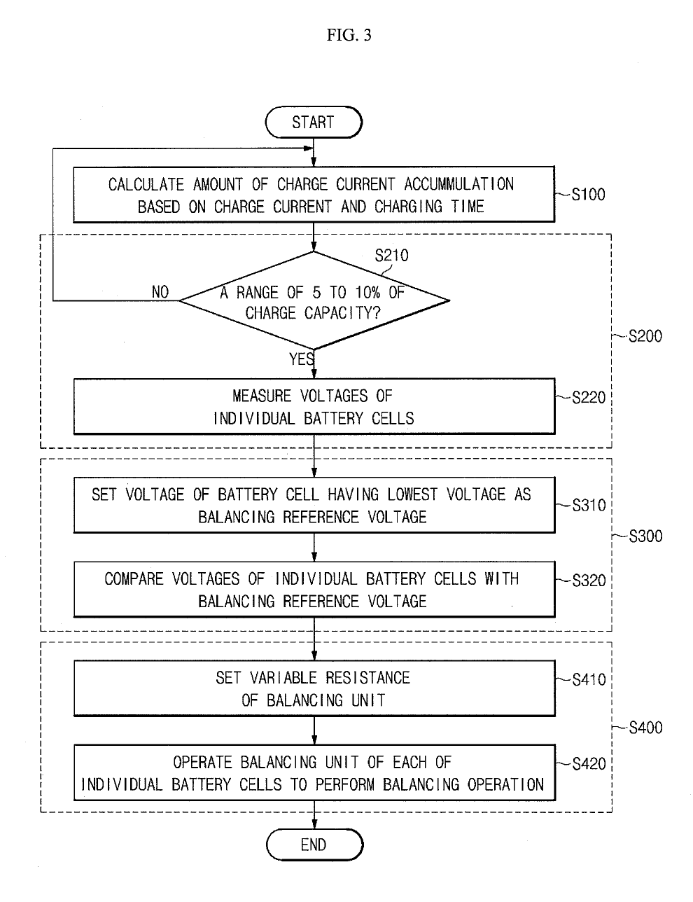

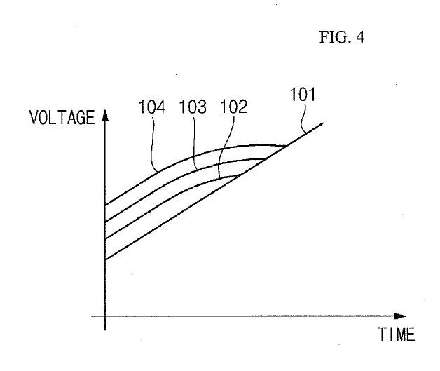

FIG. 2 is a flow chart illustrating a method of charging and discharging using the control system shown in FIG. 1, FIG. 3 is a flow chart illustrating the method of charging and discharging shown in FIG. 2, and FIG. 4 is a graph illustrating voltage differences if balancing of a plurality of battery cells is performed by the method shown in FIG. 2.

The method of charging and discharging using the battery pack control system includes calculating an amount of current accumulation (S100), sensing voltages of individual battery cells (S200), comparing the sensed voltages of the individual battery cells (S300), and balancing of battery cells (S400).

The calculating of the amount of current accumulation (S100) comprises measuring a current based on the difference of the current passing through the current sensor 120 of the plurality of battery cells 111, 112, 113 and 114 and calculating the amount of current accumulation based on the current and a time for the flow of current. The amount of current accumulation can be calculated using the following equation:

Amount of current accumulation (Ah)=Current (A) flowing in battery pack×Time (h). In some embodiments, the current through the current sensor 120 is integrated over time.

The sensing of the voltages of individual battery cells (S200) comprises comparing the calculated amount of current accumulation with the reference capacity value, and sensing voltages of the individual battery cells 111, 112, 113 and 114 if the calculated amount of charge current accumulation is in a range of the reference capacity values.

In this embodiment, the sensing of the voltages of individual battery cells (S200) comprises setting 5 to 15% of charge capacity of the battery pack as the reference capacity value and determining whether the calculated amount of charge current accumulation is in the range of the reference capacity values (S210). For example, if the charge capacity of the battery pack is 50 Ah, if the calculated amount of current accumulation is in a range of 2.5 Ah to 7.5 Ah, it is determined that the reference capacity value is reached. Preferably, if the calculated amount of current accumulation is 5 Ah, it is determined that the reference capacity value is reached. In this case, if the battery pack 110 is charged or discharged, a polarization voltage is generated with respect to battery electromotive force. The polarization voltage is increased during charging, and is reduced during discharging, causing a variation in the voltage. If the reference capacity value is reached, it is assumed that polarization voltages of the individual battery cells 111, 112, 113 and 114 are equal to each other.

In addition, if the calculated amount of charge current accumulation is less than the reference capacity value, the determining whether the calculated amount of charge current accumulation falls under a range of the reference capacity value (S210) is repeated until the calculated amount of charge current accumulation falls under a range of the reference capacity value. In the following example, the battery pack 110 has a charge capacity of 50 Ah and the reference capacity value is 5 Ah. In order for the calculated amount of charge current accumulation to reach the reference capacity value, a current of 50 A should flow in the battery pack 110 for at least 6 minutes. If the current of 5 A flows in the battery pack 110, the current should flow in the battery pack 110 for at least 60 minutes (1 hour).

If it is determined that the calculated amount of charge current accumulation is within a range of the reference capacity value (S210), voltages of the individual battery cells 111, 112, 113 and 114 are measured (S220).

The comparing of the sensed voltages of the individual battery cells (S300) comprises setting the lowest voltage of the battery cell as a balancing reference voltage by comparing the voltages of the individual battery cells 111, 112, 113 and 114 (S310) and selecting battery cells having higher voltages than the balancing reference voltage by comparing the reference voltage and the voltages of the individual battery cells 111, 112, 113 and 114 (S320). For example, if the first battery cell 111 among the individual battery cells 111, 112, 113 and 114 has the lowest voltage, the voltage of the first battery cell 111 is set as the reference voltage. Then, differences between voltages of the remaining battery cells 112, 113 and 114, and the reference voltage may be compared. Here, the battery cell having the lowest voltage may be one or more of the individual battery cells 111, 112, 113 and 114. The remaining battery cells may have higher voltages than the lowest voltage. However, the present invention does not limit the numbers of battery cells having the lowest voltage and the highest voltage to those listed herein.

The cell balancing (S400) includes setting resistance values of the variable resistors of the balancing units connected to the battery cells having relatively high voltages (S410) and the balancing unit having the variable resistance set performing a balancing operation on the battery cells having relatively high voltages to have voltages equal to the reference voltage (S420). In addition, in the cell balancing (S400), a discharge current (I_{D}) flowing in the balancing unit 130 is less than a charge current (I_{C}).

In the cell balancing (S400), the battery cells 112, 113 and 114 having relatively high voltages are discharged to correspond to the respective voltage differences. In this case, the battery cells 112, 113 and 114 may be configured to have different voltage differences. Thus, the setting of the variable resistor values (S410) comprises setting resistance values of variable resistors 132R, 133R and 134R of the balancing units 132, 133 and 134 connected to the battery cells 112, 113 and 114 so as to correspond to the voltage differences. In addition, in balancing (S420), the switches 132S, 133S and 134S of the balancing unit 130 are turned on so as to balance the battery cells 112, 113 and 114.

Control signals of the switches 132S, 133S and 134S and signals for setting the resistance values of the variable resistors 132R, 133R and 134R may be activated sequentially or simultaneously. That is to say, the battery cells 112, 113 and 114 are balanced by turning the switches 132S, 133S and 134S on during charging so as to reduce charging degrees of the battery cells 112, 113 and according to the resistance values of the variable resistors 132R, 133R and 134R.

In addition, the cell balancing (S400) may be performed repeatedly at relatively short intervals rather than continuously. Further, the sensing of the voltages of individual battery cells (S200) and the comparing of the sensed voltages of the individual battery cells (S300) are continuously performed while the battery pack 110 is charged and discharged. In addition, the balancing corresponding to the voltage differences (S420) comprises balancing by changing the resistance values of the variable resistors 132R, 133R and 134R. Therefore, according to the discussed embodiments, since charging and discharging are performed while performing cell balancing based on the voltage differences of the individual battery cells, the charging and discharging are performed in an accurate and stable manner.

Certain embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure.

What is claimed is:

1. A control system of a battery pack, the system comprising:
a plurality of battery cells;
a balancing unit configured to selectively balance the battery cells; and
a controller configured to control the balancing unit,
wherein the controller calculates an amount of charge current accumulation and measures voltages of the respective battery cells, and controls the balancing of at least one of the battery cells if the calculated amount of charge current accumulation is within a range of reference capacity values.

2. The control system of claim 1, wherein the controller comprises:
a charge current accumulation amount calculation unit configured to calculate an amount of current accumulation based on a current of the plurality of battery cells and a time for the flow of current;
an individual battery cell voltage sensing unit configured to compare the calculated amount of current accumulation with a reference capacity value, and if the calculated amount of current accumulation is within the range of reference capacity values, to sense voltages of the individual battery cells;
an individual battery cell voltage comparison unit configured to compare the sensed voltages of the individual battery cells with each other; and
an individual battery cell balancing controller configured to control battery cells having relatively high voltages to be balanced based on the voltage difference between the individual battery cells.

3. The control system of claim 1, wherein the controller controls a discharge current flowing toward the balancing unit to be less than a charge current.

4. The control system of claim 1, wherein the controller sets a reference capacity value to about 5 to about 15% of a charge capacity of the battery pack.

5. The control system of claim 1, wherein the balancing unit includes switches and variable resistors.

6. The control system of claim 5, wherein the balancing unit is connected to each of the plurality of battery cells and the variable resistors connected to different battery cells are set to have different resistance values.

7. A method of charging and discharging a battery pack using a control system of the battery pack, the method comprising:
calculating an amount of charge current accumulation based on current of the plurality of battery cells and a time for the flow of the current;
comparing the calculated amount of current accumulation with a reference capacity value;
if the calculated amount of current accumulation is within a range of reference capacity values, sensing voltages of individual battery cells;
comparing the sensed voltages of the individual battery cells with each other; and
controlling battery cells having relatively high voltages to be balanced based on the voltage difference between the individual battery cells.

8. The method of claim 7, wherein sensing the voltages of the individual battery cells comprises setting a reference capacity value to about 5% to about 15% of a charge capacity of the battery pack.

9. The method of claim 7, wherein sensing the voltages of the individual battery cells comprises measuring the voltages of the individual battery cells if the calculated amount of current accumulation is within a range of the reference capacity.

10. The method of claim 7, wherein comparing the sensed voltages of the individual battery cells comprises comparing voltages of the individual battery cells and setting the lowest voltage among the voltages of the individual battery cells as a balancing reference voltage.

11. The method of claim 7, wherein comparing the sensed voltages of the individual battery cells comprises comparing the balancing reference voltage and the voltages of the individual battery cells to obtain voltage differences between the individual battery cells to determine whether to balance the battery cells.

12. The method of claim 7, wherein balancing the battery cells comprises controlling resistance values of variable resistors included in the balancing unit so as to charge the individual battery cells to the balancing reference voltage based on the voltage differences.

13. The method of claim 12, wherein controlling the resistance values of the variable resistors comprises setting the variable resistors connected to different battery cells to have different resistance values.

14. The method of claim 7, wherein balancing the battery cells comprises controlling switches included in the balancing unit to be turned on or off.

15. The method of claim 7, wherein balancing the battery cells comprises controlling a discharge current flowing toward the balancing unit to be less than a charge current.
